(19) United States
(12) Patent Application Publication
(10) Pub. No.: US 2005/0184954 A1
(43) Pub. Date: Aug. 25, 2005

(54) Portable communication system

(76) Inventors: Michael Dewayne Adams, Saratoga, CA (US); Steven L. Mizera, Silverado, CA (US)

Correspondence Address: Law Offices of James J. Ralabate, 5792 Main St., Williamsville, NY, 14221, US

(21) Appl. No.: 10/784,386

(22) Filed: Feb. 23, 2004

(51) Int. Cl. G09G 5/00; G09G 5/08

(52) U.S. Cl. 345/156

(57) ABSTRACT

This invention involves a portable communication system where there is a service point unit and an attached second computer unit and whereby the second computer unit is a hands-free activated computer that communicates with a computer in the service unit that will interact with a hands-free computer.

This invention relates to a portable computer communication systems utilizing a mobile mini-server and mobile hands-free user supported computers.

### BACKGROUND OF THE INVENTION

In U.S. Pat. No. 5,844,824 (Newman, et al) owned by the same entity as the present invention, a hands-free computer is disclosed. In Newman, et al, the invention is directed to a compact, self-contained portable computing apparatus at least part of which is completely supported by a user for hands-free retrieval and display of information for the user. The computing apparatus includes a housing which may or may not have securing means for removably securing the housing to a user for support by the user. Alternatively, the housing may be located in a remote location not attached to the user and apart from the other components. The housing further includes storage means for storing previously entered information, and processor means, communicating with the storage means, for receiving, retrieving and processing information and user commands in accordance with a stored program. Since large databases of ETMs and IETMs will be accessed by the mobile self-contained computing apparatus, a means of easily interfacing storage means containing the database is required. The housing of the computing apparatus includes an access port whereby various storage means containing data can be interfaced and communication established. Access and transfer of data between the storage means and the computing apparatus can be accomplished entirely under control of various hands-free activation means described in this application. The access port allows direct electrical attachment of the storage means; however, other wired and wireless connections are also used. The computing apparatus also includes eye tracking, brain actuation means, transducer and converter means with or without audio transducer and converter means in communication with the processor means, for receiving commands from the user, for converting the received commands into electrical signals, for recognizing the converted electrical signals, and for sending the recognized electrical signals to the processor means. The transducer and converter means may or may not be supported by the user. The computing apparatus further includes display means in communication with the processor means for receiving information from the processor means and for displaying the received information for the user, the display means being supported by the user whereby the user may operate the computing apparatus to display information in a hands-free manner utilizing in one embodiment only audio commands. The disclosure of U.S. Pat. No. 5,844,824 is incorporated by reference into the present disclosure.

Therefore, in Newman, et al, in one embodiment a user can wear (or support) only the computer display means and the hands free activation means (usually voice activation), and the computer housing is unattached from the user and is located at a remote location. While the user or users can support a computer or computer housing while using a remotely located computer it is also within Newman's invention that just the display and hands-free activation need to be worn or user supported. The remotely located computer in Newman, et al permits it to network with several other computers or computer displays-activation means.

In U.S. Pat. No. 5,671,436 (Morris, et al), the disclosure of which is incorporated by reference into the present disclosure, a system is disclosed for collecting data from remote sites and transmitting the collected data to a main information center. Morris' system includes a mobile server that can be transported to various locations with respect to the main information center and remote sites. Morris, et al (Morris) utilizes a plurality of portable terminals working with a first and second mobile server. Morris states that his invention involves a system for collecting data from at least one remote site and transmitting the collected data to a main information center. The system has information distributed throughout and is divided into first, second, and third portions. The system includes at least one portable terminal for collecting data at the remote site. The terminal comprises a first memory for storing the first information portion. The terminal operates by a programmed computer to sense the need for information for its use to generate an information call identifying the needed information, and to respond to the information call for searching its first memory for the presence or absence of that needed information. If that needed information is available in the first memory of the terminal, it is supplied for use by the portable terminal. The system further comprises a first mobile server to be transported to various locations with respect to the main information center and the remote site. The first mobile server comprises a second memory for storing the second information portion, and responds to the information call for searching the second memory for presence or absence of that needed information. The system further includes a second server at the main information center which comprises a third memory for storing the third information portion, and operates to search the third memory for the presence or absence of that needed information.

There are other prior art disclosures on the use of mobile servers that include the capability of storing various types of multi-user data and transmitting the data to other users of a terminal. These systems use mobile servers to increase the flexibility of terminals for receiving and utilizing multi-user data transmitted from manually activated terminals without requiring large amounts of memory within the terminal itself. Examples of mobile server-terminal systems are disclosed in US Patent Application Publication (A) U.S. 2003/0157959 and (B) 2002/0151271. In all of these prior art systems mobile servers are used together with hand held manually-operated terminals and not with full functioning hands-free voice-activated computers. Since mobile servers are well known in the prior art a detailed description of them and their function is not deemed necessary for the understanding of the present invention.

### SUMMARY OF THE INVENTION

It is therefore an object of this invention to provide a hands-free mini-server computer terminal system devoid of the above-noted disadvantages.

Another object of this invention is to provide a novel mobile mini-server that can be used in a computer communication system to communicate with at least one mobile voice-activated computer(s), (second computer(s).

Yet another object of this invention is to provide a hands-free system utilizing a mobile server that enables any mini-server with the proper software to perform as if it were many users' personal computer.

Still a further object of this invention is to provide a mini-server system comprising as a component of the system a mobile server and a mobile user-supported computer both to operate in a hands-free manner.

Yet a further object of this invention is to provide a communication system having a voice activated mobile server in wireless communication with at least one user supported voice activated computer (second computer) as a terminal(s).

A yet still further object of this invention is to provide a system which will allow users to access and manage incoming calls or messages received through their miniserver interface to their wearable computers.

Still yet a further object of this invention is to provide a powerful mobile mini-server that travels anywhere its user needs to go.

Another object of this invention is to provide a voice-activated server and computer (terminal) with means for data collection and transmission that is easy, reliable and efficient.

These and other objects of this invention are accomplished by a novel mobile hands-free activated server called ServicePoint. In a client/server computing architecture, ServicePoint is a new invention providing new and enhanced functionality to the capability on the client/network computer side by adding extreme mobility through wearable computing technology, and sustainability in what would be traditionally characterized as hostile computer/server environments. Hostile environments for computing can generally be described as outdoors and exposed to the elements with no readily available AC power source or vehicular powered inverters. The voice activation capability is a key component facilitating the mobility and support in this hostile client/server environment. The system of the present invention utilizes a Xybernaut Corporation mini-mobile server called ServicePoint™. This mini mobile server travels anywhere its users need to go thereby making data collection and transmission easy, reliable and efficient. ServicePoint mobile mini-server in one embodiment runs an open source operating system such as Linux® Redhat Professional and includes the popular MYSQL database program along with HTML, Perl and other browser enabling programs. Other operating systems including proprietary software such as Microsoft family of server software (e.g., Windows Server 2003) and Apple Computer, Inc. Mac OS X Server software and open source software such as Sun Microsystems Inc. Java server software or other suitable software may also be used. By “Operating Server Software” in this disclosure and claims is meant to include Linux® Redhat Professional Operating System, the known MYSQL database program, HTML, Perl and other browser enabling programs. Also, other known operating systems including the Microsoft family of server software (e.g. Windows Server) and Apple Computer Inc. Mac OS Server Software and open source software such as Microsystems Inc. Java server software or other suitable software. All of the above are included in “Operating Server Software” useful in this invention and defined in the claims. Obviously, these “Operating Server Software” must be compatible with hands-free user-supported computers such as the MA family of computers provided by Xybernaut Corporation; this is critical to the present invention.

A compact flash card may also be included in the mini-server of this invention. This flash card can be included in the hands-free computer component (“first computer”) or (“host computer”) of the mini-server or the flash card can be a free-standing separate component of the mini-server.

This ServicePoint is adapted to be used in a system that includes reception from at least one voice-activated computer such as the Xybernaut MAV user-supported voice-activated computer. In one embodiment, ServicePoint has an Intel® Mobile Celeron® processor with state-of-the-art functionality and enough power to run enterprise applications. It is 5.9″×3.5″×2″ and is encased in a magnesium alloy shell for durability. An ultra low voltage, low heat CPU is powered by rechargeable Lithium-ion batteries. It is to be understood that other types of processors and enclosure sizes may be used including Intel Xeon family of processors, AMD Athlon or Opteron processor line, Apple's Power PC G4 or G5 made by Motorola and IBM respectively, or other suitable processor types. ServicePoint is a mobile application services platform that allows integrated wireless and hard-wired communications through fixed and mobile LAN/WAN networks for data, voice and video.

As above noted, the system of the present invention utilizes a Xybernaut Corporation mini-mobile server called ServicePoint™. This mini mobile server travels anywhere its users need to go thereby making data collection and transmission easy, reliable and efficient. ServicePoint mobile mini-server in one embodiment runs Linux® Redhat Professional and includes the popular MYSQL database program, along with HTML, Perl and other browser enabling programs. Other server operating systems including the Microsoft family of server operating systems may also be used if it is compatible with voice activation. It can be configured to function as an access point on its own, can connect with other wireless access points and works with industry standard wireless protocols. Continuous communications among all connected devices means that work does not stop. ServicePoint mobile mini-server keeps data collection teams productive throughout the workday and maintains data flow from the field to centralized operations systems. Data flows reliably and accurately, even from remote and unwired locations. ServicePoint is different from prior art servers in that ServicePoint contains a voice-activated mobile computer or a computer compatible with the second computers which must be voice activated. ServicePoint has the capability to interact with, to receive and transmit data with hands-free (usually voice) activated computers, not, as stated earlier in the Background of Invention, manually activated terminals and mobile servers as utilized in the prior art. The mini-mobile server of this invention is hands-free activated (hereinafter “voice-activated”) and the terminals are not just terminals but rather include hands-free activated computers such as Xybernaut Corporation's MA® hands-free computers and Atigo® computers, i.e. “second computers”. While Atigo® can be manually activated it also has hands-free activation capabilities. By “voice activation” as used throughout this disclosure includes all of the hands-free activation means disclosed in U.S. Pat. No. 5,844,824 including audio activation means, eye-tracking activation means, electroencephalography activation means and mixtures thereof.

The hands-free distinction is important to the present invention since for example, a soldier in combat while holding his weapon can still communicate with the ServicePoint server by voice activation. This permits him or her the use of their hands while using his or her voice-activated user-supported computer to convey a message or data to the voice-activated ServicePoint mini-server. The components in a ServicePoint mini-server are a battery, a MA5, or other voice-activated user-supported computers, first computer(s) or voice receptive computers (to function and respond to the second voice activated computer in the system), wireless capabilities, software for servers such as Linux Red Hat Professional Operating system. ServicePoint is a mobile application services platform that allows integrated wireless and hard-wired communications through fixed and mobile LAN/WAN networks for data, voice and video.

The technical specifications of one embodiment of ServicePoint mobile mini-server are:
Processor: 500 MHz Intel®, Mobile Celeron®, ultra low voltage;
Memory and Storage: 256 MB SDRAM, 5 GB or 10 GB Internal HDD, expandable, with optional external drive;
Ports: Compact Flash, USB, DC-IN jack, user interface port (supports LVDS and GVIF), PDP (Power Docking Port) for connection to the MAV Holster, power switch, hibernate switch;
Audio/Video: Video memory 8 MB SDRAM, built-in sound card, full-duplex, stereo I/O, integrated Digital Signal Processor (DSP), Texas Instruments TMS320C5416™;
CPU Chassis: Durable magnesium alloy case, 5.9″×3.5″×2″ (15 cm×9 cm×5 cm), approximately one pound (455 g);
Holster: CPU Module connects to the optional holster for extended connectivity and operation, 1 type II or III PCMCIA card slot, USB, FireWire® (iLINK®), VGA and Power Docking port;
Battery: Primary and secondary lithium-ion batteries, AC power adapter/battery charger with protective circuitry;
Software: Linux® Redhat Professional

The Atigo® computer terminal is described in U.S. Pat. No. 6,421,232 and the MA series of user supported computers are described in U.S. Pat. Nos. 5,305,244 and 5,844,824, all of which are incorporated by reference into the present disclosure. The only additional information necessary to understand the present invention is that in one preferred embodiment both the mini-server(s) and the computers or terminal(s) second computers must have voice activation. This feature is very critical for several intended uses such as the military, police and fireman usage, teams such as salespeople, health inspectors, engineers, utility repair people, etc. where the use of the user's hands are vital when he or she needs to communicate by voice or other hands-free activation means.

Also, the mini-server user-supported system of this invention may in one embodiment also comprise a communication interface like a cell phone, two-way radio or any other suitable communication means that can be used for voice or verbal communication if necessary. By “headset(s)” or “HMD” or “Display” is meant to include any other type display such as a flat panel display, a neck hung display or any other suitable display. When using the hands-free computer apparatus of this invention with a communication interface (such as a cellular phone), the following components are used:

Major components considered for communication interfaces:
(HMD) Headsets—containing communication interface capabilities.
Components: Headband Unit
   Display Screen
   Transducer and converter containing microphone and conversion/transceiving means

Computer Unit—known also as host computer; may also be totally integrated with headset housing.

Configurations:

First Mode—wireless headset to host computer
Second Mode—wireless several headsets to host computer
Other Modes—several hosts to each headset to headset communication-(primarily, but not limited to voice since data may be transmitted on the voice channel using a built-in modem within the headset electronics.)
Local—wireless link to another headset
Remote Through
   Wireless transmission—cellular phone to telco system back to cellular phone then to another headset

Host to Host Communication
Wireless local transmission wireless link to another local host (local is defined as in the immediate geographical area—for low power communications
Remote wireless transmission—(remote is defined as outside the immediate geographical area requiring higher power communications or a backbone system).
   It is obvious that all communications that can be conducted using wireless means but could also be conducted using hardwire or fiberoptic or other suitable connections. Various workable embodiments are:
Wireless Modes:
   Headset to Host (Local)
   Headset to Host (Remote)
   Headset to Headset (Local)
   Headset to Headset (Remote)
Wireless Transmission Means
   Radiofrequency
      Radio link
      Spread spectrum
      Cellular telephone link
   Infrared link
      Directed or not dispersed
      Dispersed or omnidirectional
   Underwater Link
      Radio frequency
      Sonic
      Infrared
   Light Frequency link
      Visible
      Invisible

The novelty in the present invention resides in a system that comprises:
1. a ServicePoint mobile server that has audioactivation means and the ability to communicate audibly with
2. at least one user-supported, voice-activated computer (second computer)
3. both of which are mobile and can go anywhere with the user.

Many users of user-supported (including wearable computers) cannot use their hands because they may be holding tools or a weapon and must rely upon voice activation to communicate with a mobile server; the prior art mobile servers do not allow for this interaction.

### BRIEF DESCRIPTION OF THE DRAWING

FIG. 1 is a perspective view of the user-supported computer-mobile server system of this invention.

FIG. 2 is a perspective top view of the novel mini-server ServicePoint of this invention.

### DESCRIPTION OF THE DRAWING AND PREFERRED EMBODIMENTS

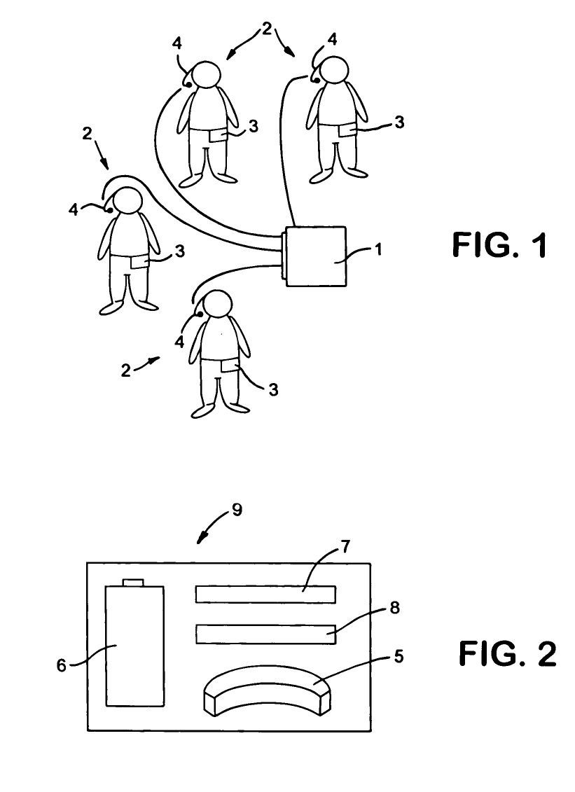

In FIG. 1 a system is illustrated using a ServicePoint mini-server 1 configured to function as an access point linked in a wireless manner to end-users 2. The mini-server communicates to multiple computers including user-supported computer 3 such as a Xybernaut MAV having voice activation or microphone activation means 4 that are in wireless audio communication with a ServicePoint server 1. Note that the computer operator or user has his or her hands free when communicating with ServicePoint 1. This is critical to the system of the present invention, since it permits the user to use his or her hands to repair a disabled item such as a vehicle as a plane, a computer, a machine, etc. The voice-activated computer (second computer) 3 can be the same or different from the voice-activated computer used in a ServicePoint server 1 (first computer). They must, however, be compatible, for example, both voice activated so they can communicate with one another. In one embodiment battery 6 in FIG. 2 is a necessary component of a ServicePoint server as is voice compatible computer 5.

Obviously, the computers 3 (second computer) and the ServicePoint 9 must have wireless communication capabilities to function in the present system.

The preferred and optimumly preferred embodiments of the present invention have been described herein and shown in the accompanying drawings to illustrate the underlying principles of the invention but it is to be understood that numerous modifications and ramifications may be made without departing from the spirit and scope of this invention.

1- A portable mobile computer mini-server comprising in electrical connection at least one of each of the following components: a first hands-free activated general purpose computer (“first computer”), an Operating Server Software and a battery, said first voice-activated hands-free general purpose computer having hands-free activation means and means to communicate and exchange information with a second voice-activated computer (second computer(s)) which is located remotely relative to said first voice-activated hands-free general purpose computer, said mini-server having means to function as a server for at least one of said second computers, said hands-free activation means selected from the group consisting of audio activation, electroencephalography activation, eye activation, hand and arm-tracking means and mixtures thereof.

2- The server of claim 1 wherein all of said components are encased in a weatherproof housing including a magnesium alloy shell.

3- The server of claim 1 having a PCMCIA card slot in said first computer.

4- The server of claim 1 having at least one primary or at least one secondary battery and means for connection to an outside power source.

5- The server of claim 1 having video memory and a built-in sound card.

6- The server of claim 1 having at least one integrated Digital Signal Processor.

7- The server of claim 1 having a compact flash, USB, DC-IN jack, user interface ports, a power port for connection to an outside power source and at least a 500 MHz processor.

8- A communication system comprising at least one mini-server and apart from said mini-server at least one second hands-free activated general purpose computer (“second computer”), said mini-server comprising at least one each of the following components: a first hands-free activated general purpose computer (first computer), a compact flash card, an Operating Server Software, and a battery, said first computer having means to communicate and exchange information with said second computer which is located remotely relative to said first computer, said mini-server having means to function as a server, at least one of said second computers using a wireless protocol to communicate, said hands-free activated general purpose computer having activation means.

9- The system of claim 8 wherein said user-supported hands-free computer and ServicePoint have means for also communicating and interacting with a communication means selected from the group consisting of cellular telephones, hard line telephones, infrared transceivers, two way radio means and mixtures thereof.

10- The system of claim 8 wherein said mini-server comprises in electrical connections, a battery, a suitable Operating Server Software, wireless communication means, a compact flash card, and a voice-activated general purpose first computer, said first computer having means to communicate and exchange information with a second voice-activated computer remotely located relative to said first computer, said first computer having means to function as an access point for at least one of said second computers.

11- The system of claim 8 wherein the second computer permits a user to wear only a display and an activation means which is adapted to interact with said first computer.

12- The system of claim 10 wherein said second computer comprises a display means selected from the group consisting of a head mounted display, a wrist mounted display, a neck hung display, a flat panel display and mixtures thereof.

13- The system of claim 10 wherein said mini-server and both said first and second voice activated computer have other means to operate in addition to said voice activated, said other means include electroencephalography activation means, eye activation means, head and arm tracking means, and mixtures thereof, and whereby the first computer has means to interact with said other means.

14- The system of claim 10 wherein said second voice activated computer has a single computer housing and wherein a computer display, said voice activation means are combined into said single housing together with all of the components of a general purpose computer.
